(19) United States
(12) Patent Application Publication
(10) Pub. No.: US 2013/0091047 A1
(43) Pub. Date: Apr. 11, 2013

(54) SYSTEM AND METHOD FOR GROUP PURCHASING

(71) Applicants: Guy Maxwell HOUGH, Roseville (AU); Tobias Edward Loneragan, Bondi Beach (AU); Kieran Anthony Martin, North Curl Curl (AU)

(72) Inventors: Guy Maxwell HOUGH, Roseville (AU); Tobias Edward Loneragan, Bondi Beach (AU); Kieran Anthony Martin, North Curl Curl (AU)

(73) Assignee: Group Property Holdings Pty Ltd, Roseville (AU)

(21) Appl. No.: 13/486,397

(22) Filed: Jun. 1, 2012

(30) Foreign Application Priority Data
Oct. 6, 2011 (AU) 2011904130
Nov. 14, 2011 (AU) 2011101461

(51) Int. Cl. G06Q 40/04

(52) U.S. Cl. 705/37

(57) ABSTRACT

A method for conducting an online group auction of homogeneous shares in an undivided lot uses a server computer accessible via a data network. An associated database contains details of an undivided lot, such as a real estate property, available for auction, and information representing a share offering. The offering comprises a number of homogeneous shares in the undivided lot, each share having an associate individual share price. Participating bidders submit bids via the data network, each bid including information identifying a maximum number of shares, and a maximum price per share. The server determines a degree of success of the bid based on an extent to which the maximum price per share exceeds a current individual share price of one or more of the homogeneous shares. The server then updates the information representing the share offering in accordance with the determined degree of success of the bid.

### FIELD OF THE INVENTION

The present invention relates to the conduct of automated interactive auctions via data communication networks, such as the Internet, and more particularly to the conduct of a group auction via automated electronic means.

### BACKGROUND OF THE INVENTION

Methods and systems for conducting interactive automated online auctions are known. For example, one such system is disclosed in U.S. Pat. No. 5,835,896, in the name of Allan Fisher and Samuel Kaplan issued on 10 Nov. 1998, and currently assigned to eBay, Inc. This patent describes a system and method of conducting a multi-person interactive auction, in a variety of formats, without using a human auctioneer. The system allows a group of bidders to interactively place bids over a computer or communications network, where the bids are recorded by the system and the bidders are updated with the current auction status information. When appropriate, the system closes the auction from further bidding, and notifies the successful and unsuccessful bidders as to the auction outcome.

Existing online auction systems, such as eBay, allow for the auction of single items, or of groups of identical items. For example, an item may be placed on an online auction site, and an automated interactive auction conducted with the item ultimately being sold to the highest bidder. If there are multiple identical items, then one or more of these items may be sold as a result of a single auction to the corresponding number of highest bidders.

Online auction sites may be used to sell high-value items to individual bidders. For example, it is now relatively common for cars to be sold via automated online auctions, while as early as 2001 a business jet was sold on eBay for US $4.9 million.

Clearly, such high-value items are beyond the reach of most individual purchasers. It is possible for groups of individuals to combine in order to make joint purchases or investments in high-value assets. This may be achieved through the formation of syndicates, collectives, funds and the like, such that a single entity is created through which a high-value purchase may be made, with the various participants all holding an interest.

However, such group purchases generally require all parties to reach agreements in advance regarding the legal and financial structures involved. Ultimately, the acquisition of the high-value asset remains a single purchase by a single entity, albeit one in which a plurality of individuals share an interest.

US patent application no. 2006/0190277, in the name of Ronald Zimmerman and Jack Donenfeld, which was published on 24 Aug. 2006, discloses an automated system to provide an online marketplace to enable real estate sellers, passive real estate investors, master lessees and sponsors of tenancy in common (TIC) transactions to contract regarding fractional and other real estate interests. The system disclosed in this document enables vendors to place real estate properties on the market, and enables investors to purchase fractional interest in properties for sale. Vendors and investors provide profile information, and the system compares the vendor and investor profiles in order to identify suitable matching parties because the matching is based upon the investor profile, i.e. the investors' desired characteristics in a property investment, and is not configured to enable an investor to select a particular property in which to purchase a fractional interest. The real estate investors are passive, in the sense that once they have provided funds for investment, they know that these will be allocated in accordance with the information in their profile, but they do not know precisely which property, or properties, their funds are invested in at any particular time. In this sense, the scheme is closely analogous to investing in the share market via a mutual fund.

There is no method or system in the prior art known to the present inventors which enables an acquainted individual to purchase a fractional stake in specific undivided, or indivisible, assets via an open and transparent competitive auction process.

It is, accordingly, an objective of the present invention to provide such a method and system.

It is a further objective of at least some embodiments of the invention to enable fractional interests in assets purchased using the system and method to be fungible. As used in this specification, the term ‘fungible’ as applied to shares in a single asset or other undivided lot, is defined to mean that the shares are freely interchangeable and exchangeable with items of a like nature or kind, including currency or an equivalent. As such, it is an objective of at least some embodiments of the invention to enable fungible shares to be on-sold via the same online automated auction system and method.

Further objects will be apparent to the skilled reader from the following disclosure of embodiments of the invention.

### SUMMARY OF THE INVENTION

In an embodiment the invention provides a method for conducting a group auction of homogeneous shares in an undivided lot via a data network, the method comprising steps of:

providing a server computer having an associated database containing details of an undivided lot available for auction, and information representing a share offering, comprising a number of homogeneous shares in the undivided lot, each share having an associated individual share price;

the server receiving from one of a plurality of bidders, via the data network, new bid information comprising data identifying a maximum number of shares, and data identifying a maximum price per share;

the server determining a degree of success of the bid based on an extent to which the maximum price per share exceeds a current individual share price of one or more of the homogeneous shares; and

the server updating the information representing the share offering in accordance with the determined degree of success of the bid.

Advantageously, embodiments of the method enable a plurality of unacquainted individual bidders to place bids for one or more of any number of homogeneous shares in the undivided lot. As bidding progresses, shares may generally end up being priced differently, while the total value of all shares remains the highest possible based upon the history of bids received from the plurality of bidders. Each new bid for at least one share and offering a maximum price which is higher than at least one of the shares already allocated to a prior bidder will result in a share allocation to the new bidder, and an overall increase in the total price of shares in the undivided lot.

In embodiments of the invention further bids are received, and the steps of determining a degree of success in each new bid, and updating the information representing the share offering, are repeated until an auction termination condition is satisfied. The auction termination condition may be, for example, a time limit, or a desired total valuation of the undivided lot.

An embodiment of the invention operates such that if the number of shares available is greater than the maximum number of share identified in the new bid information, the degree of success is determined to be equal to the maximum number of shares, and the information representing the share offering is updated to reflect an allocation to the bidder of the same maximum number of the homogeneous shares at a minimum share price. The minimum share price may be predetermined before commencement of the auction. In this way, all shares are initially allocated to bidders at the predetermined minimum share price, until sufficient bids have been received that all of the originally available shares have been allocated.

The minimum share price may therefore be set to establish a minimum value of the undivided lot prior to commencement of the auction. Furthermore, the number of available shares may be set such that the minimum share price represents an attractive purchasing opportunity to a sufficient number of bidders to enable an effective competitive auction.

An embodiment of the invention further operates such that if the number of shares available is less than the maximum number of shares identified in the new bid information, the degree of success in the new bid is determined to be equal to a number of homogeneous shares, up to the identified maximum number, having an associated maximum price per share based upon a prior bid which is lower than the maximum price per share identified in the new bid information, and the information representing the share offering is updated to reflect an allocation to the bidder of the number of shares corresponding with the determined degree of success.

Advantageously, therefore, the bidder will receive an allocation of a number of shares up to the maximum requested, to the extent that the offered maximum price is higher than maximum prices offered by prior bidders. The auction may be conducted transparently, such that each new bidder is able to determine an offer which will result in the allocation of at least some shares at no more than a specified maximum price.

Furthermore, in an embodiment each allocated homogeneous share comprises an associated bidder and an associated maximum price, and a degree of success of the new bid is determined by a method which comprises identifying all shares having an associated maximum price which is less than the maximum price per share of the new bid, wherein the degree of success is equal to the lesser of the number of shares so identified, and the maximum number of shares identified in the new bid information.

Furthermore, each allocated homogeneous share may further comprise an associated priority relative to more other allocated shares, and the information representing the share offering may be updated using a method comprising identifying a number of outbid shares equal to the degree of success, being those shares having the lowest maximum price per share and then the lowest priority relative to other allocated shares, and associating the outbid shares with the bidder, the maximum price of the new bid, and a new minimum priority relative to all prior allocated shares.

Advantageously, assigning a lower priority to later bids means that, all else being equal, earlier bidders at the same price will retain their allocated shares in preference to later bidders. In an embodiment, the associated priority is a value representing a time of receipt of a bid on which the share was allocated, wherein earlier times correspond with higher priorities.

In an embodiment, the step of updating the information representing the share offering further comprises updating the associated individual share price of one or more of the homogeneous shares.

In particular, updating the associated individual share price may comprise setting the individual share price of shares newly associated with the bidder, and of all prior allocated shares having an individual share price less than the maximum price per share of out bid shares, to the maximum share price per share of outbid shares.

Advantageously, according to this embodiment earlier bidders who have been allocated shares at less than their nominated maximum price will effectively be ‘auto bid’ up in response to relevant subsequent bids, until the maximum price is reached, after which they may be displaced by a subsequent higher bids.

In an alternative embodiment, such as may be employed in a capital-raising round or similar, the step of updating the information representing the share offering may comprise reducing the number of homogeneous shares comprising the undivided lot, while maintaining the total value of the lot. This enables the individual share prices to be raised in accordance with a new and more favourable bid, without exceeding a predetermined total sale price.

Embodiments of the invention may further comprise providing to the bidder a visualisation of the information representing the share offering, wherein the visualisation is a two- or three-dimensional graphical representation of one or more of:

the number or proportion of shares allocated;

the absolute or relative price per share of all shares allocated;

the shares allocated to the bidder;

the shares allocated to one or more other bidders;

the total value of the undivided lot, calculated as the sum of all individual prices; and

the total commitment of the bidder, calculated as the sum of individual share prices of all shares allocated to the bidder.

The visualisation may alternatively, or additionally, comprise a time element, e.g. representing current and/or past values of visualised quantities.

Advantageously, a graphical visualisation enables each bidder easily to keep track of their own bids, their allocation, the activity of other bidders, their total individual commitment, and/or the overall progress of the auction.

Some embodiments may allow variations of the basic auction method. For example, one or more of the homogeneous shares may be ‘locked’ or otherwise unavailable for allocation. This enables the auction, or on-sale, of a subset of the homogeneous shares. For example, one individual prior bidder may wish to on-sell their allocation by a later auction, without disturbing the allocations of other previously successful bidders.

In another variation, a bidder may be permitted to make a ‘preferential’ bid, comprising a price premium over a current maximum share price, in response to which the server may update the information representing the share offering to allocate the requested number of shares at the premium price, and lock the allocation such that those shares are no longer available for allocation to subsequent bidders. Advantageously, such a variation provides for a ‘buy now’ function available to a bidder who is willing to pay the price premium.

In another variation, the number of homogeneous shares may be dynamic during the course of the auction. For example, under suitable conditions shares may be split such that each successful bidder obtains an allocation of a larger number of shares, at a lower price per share, wherein the total commitment of each successful bidder remains fixed. Such a share split may be triggered, for example, by high demand from a large number of bidders.

Embodiments of the invention also encompass a computer implemented apparatus for conducting a group auction of homogeneous shares in an undivided lot via a data network, wherein the apparatus comprises:

at least one processor;

a network interface, operatively associated with the processor and providing access to the data network;

at least one memory device, operatively associated with the processor; and

a database, accessible to the processor, which contains details of an undivided lot available for auction, and information representing a share offering comprising a number of homogeneous shares in the undivided lot, each share having an associated individual share price,

wherein the memory device contains program instructions which, when executed by the processor, cause the apparatus to implement a method comprising steps of:
receiving from one of a plurality of bidders via the data network, new bid information comprising data identifying a maximum number of shares, and data identifying a maximum price per share;
determining a degree of success of the bid based on an extent to which the maximum price per share exceeds a current individual share price of one or more of the homogeneous shares; and
updating the information representing the share offering in accordance with the determined degree of success of the bid.

The memory device may contain further programming instructions comprising an application programming interface (API), which enables software executing on a remote system to access the computer implemented apparatus via the data network to request execution of auction operations, whereby services provided by the apparatus may be integrated into the remote system.

In a further embodiment the invention provides a method for conducting a reverse group auction of homogeneous shares in an undivided lot via a data network, the method comprising steps of:

providing a server computer having an associated database containing details of an undivided lot having shares allocated to one or more shareholders, and information representing a purchase offer of a buyer, comprising a requested number of homogeneous shares in the undivided lot, each share having an associated individual share price;

the server receiving from one of the shareholders, via the data network, new bid information comprising data identifying a maximum number of shares, and data identifying a minimum price per share;

the server determining a degree of success of the bid based on an extent to which the minimum price per share is lower than a current individual share price of one or more of the requested number of homogeneous shares; and

the server updating the information representing the share offering in accordance with the determined degree of success of the bid.

A further embodiment of the invention provides a computer implemented apparatus for conducting a reverse group auction of homogeneous shares in an undivided lot via a data network, wherein the apparatus comprises:

at least one processor;

a network interface, operatively associated with the processor and providing access to the data network;

at least one memory device, operatively associated with the processor; and

a database, accessible to the processor, which contains details of an undivided lot having shares allocated to one or more shareholders, and information representing a purchase offer of a buyer, comprising a requested number of homogeneous shares in the undivided lot, each share having an associated individual share price,

wherein the memory device contains program instructions which, when executed by the processor, cause the apparatus to implement a method comprising steps of:
receiving from one of the shareholders via the data network, new bid information comprising data identifying a maximum number of shares, and data identifying a minimum price per share;
determining a degree of success of the bid based on an extent to which the minimum price per share is lower than a current individual share price of one or more of the requested number of homogeneous shares; and
updating the information representing the share offering in accordance with the determined degree of success of the bid.

Further features, variations, objects and advantages of the invention will be apparent from the following detailed description of embodiments, which are provided by way of example only, and are not intended to limit the scope of the invention as described in the foregoing statements, or defined in the claims appended hereto.

### BRIEF DESCRIPTION OF THE DRAWINGS

Embodiments will now be described with reference to the accompanying drawings in which like reference numerals refer to like features and wherein:

FIG. 1 is a block diagram illustrating a network system within which embodiments of the present invention may be implemented;

FIG. 2 is a block diagram showing further details of a server configured to conduct a group auction according to an embodiment of the invention;

FIG. 3 is a schematic diagram of database content according to an embodiment of the invention;

FIG. 4 is a diagram illustrating schematically an exemplary bid record according to an embodiment of the invention;

FIG. 5 is a flow chart illustrating a method for conducting a group auction of homogeneous shares according to an embodiment of the invention;

FIG. 6 is a flow chart illustrating a method of processing a bid according to an embodiment of the invention;

FIG. 7 shows an exemplary user interface screen for bidding on and monitoring a group auction according to an embodiment of the invention; and

FIG. 8 shows a series of schematic illustrations of the conduct and visualisation of an exemplary auction according to an embodiment of the invention.

### DETAILED DESCRIPTION OF EMBODIMENTS

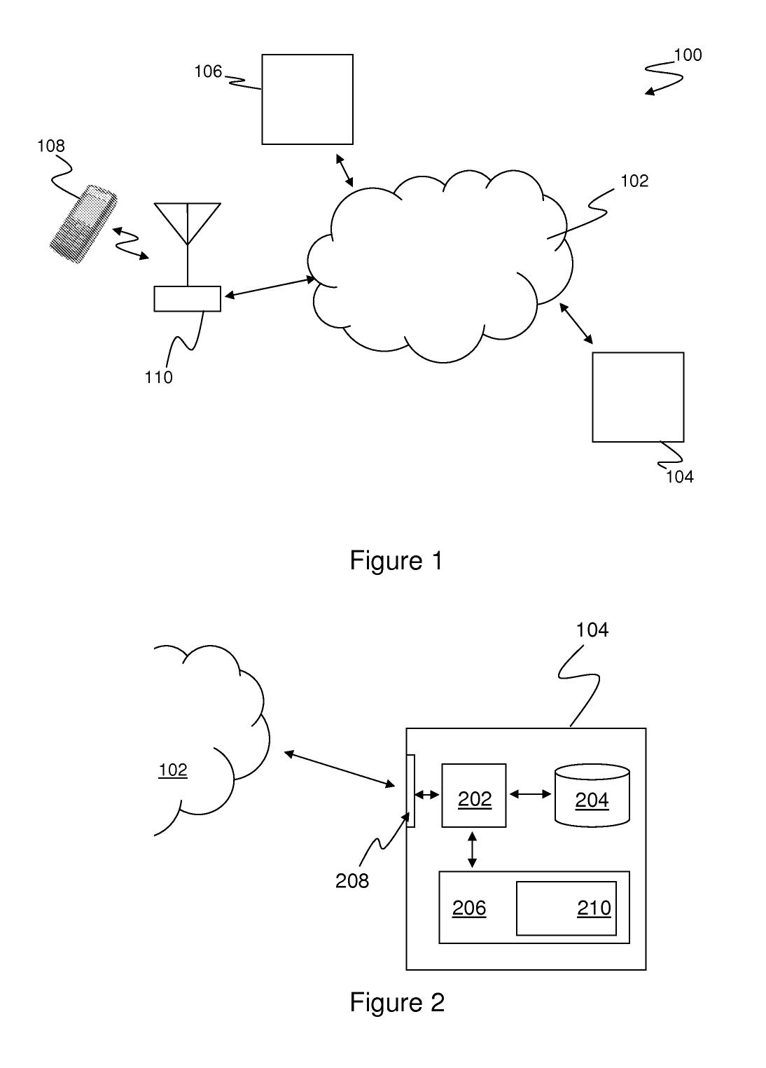

FIG. 1 is a block diagram illustrating a system 100 within which embodiments of the present invention may be implemented.

The system 100 uses a data network, e.g. the Internet 102, to provide services to participants in an online group auction via a server computer system 104. Participants may access the server 104 via client computers 106, e.g. using conventional web browser software, or from mobile devices 108, employing either web browser software or custom designed mobile applications ('apps').

As such, the server 104 may execute a web server software application for provision of its facilities to participant client devices 106, 108. Communication between the server 104 and the clients 106, 108 is thus conveniently based upon standard Hyper Text Transfer Protocol (HTTP) and/or Secure Hypertext Transfer Protocol (HTTPS). In alternative embodiments, however, dedicated client apps may be developed and installed on the consumer client devices 106, 108, in which case either standard or proprietary protocols may be used for communications between the server 104 and the clients 106, 108. All such embodiments, and variations which would be apparent to persons skilled in the relevant computer programming arts, are within the scope of the present invention.

Mobile client devices 108 access the network 102 via access points 110. The wireless access points 110 may be, for example, wireless LAN (Wi-Fi) access points, or cellular access points. As will be appreciated by persons skilled in the communication arts, various mechanisms and technologies are available to provide access to the Internet 102 from fixed and mobile devices 106, 108, within the scope of the present invention.

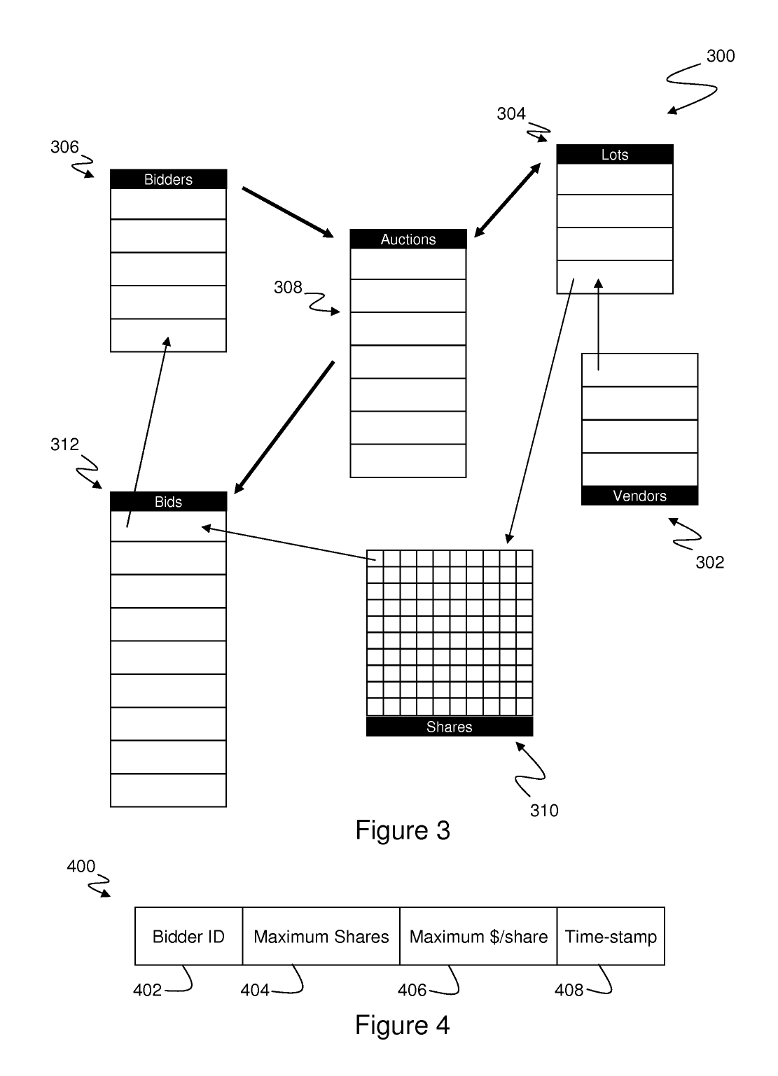

FIG. 2 is a block diagram showing further details of the server system 104.

The server 104 may generally comprise one or more computers, each of which includes at least one microprocessor 202. The number of computers and processors 202 generally depends upon the required processing capacity of the system which in turn depends upon the number of concurrent participant client devices 106, 108 requiring access to the server 104. A collection or ‘farm’ of server computers may be co-located, or may be geographically distributed and interconnected via the Internet 102.

In some embodiments a third party cloud computing platform may be employed for implementation of the server 104, thereby enabling the physical hardware resources to be allocated dynamically in response to consumer demand. These and other variations are within the scope of the present invention, however for simplicity in the remainder of the description an exemplary server system 104 includes a single computer with a single microprocessor 202.

The microprocessor 202 is interfaced to, or otherwise operatively associated with, a non-volatile memory/storage device 204. The non-volatile storage 204 may be a hard-disk drive, and/or may include a solid state non-volatile memory such as read-only memory (ROM), flash-memory, or the like. The microprocessor 202 is also interfaced to volatile storage 206, such as random access memory (RAM), which contains program instructions and transient data relating to the operation of the server 104. In a conventional configuration, the storage device 204 maintains known program and data content relevant to the normal operation of the computer system. For example, the storage device 204 may contain operating system programs and data, as well as other executable application software necessary to the intended functions of the server 104. In the embodiment shown, the storage device 204 also contains program instructions, which, when executed by the processor 202, enable the server computer to perform operations relating to the implementation to the services and facilities embodying the present invention. In operation, instructions and data held on the storage device 204 are transferred to a volatile memory 206 for execution on demand.

The microprocessor 202 is also operatively associated with a network interface 208 in a conventional manner. The network interface 208 facilitates access to one or more data communications networks, including the Internet 102, which are employed for communication between the server 104 and the participant client devices 106, 108.

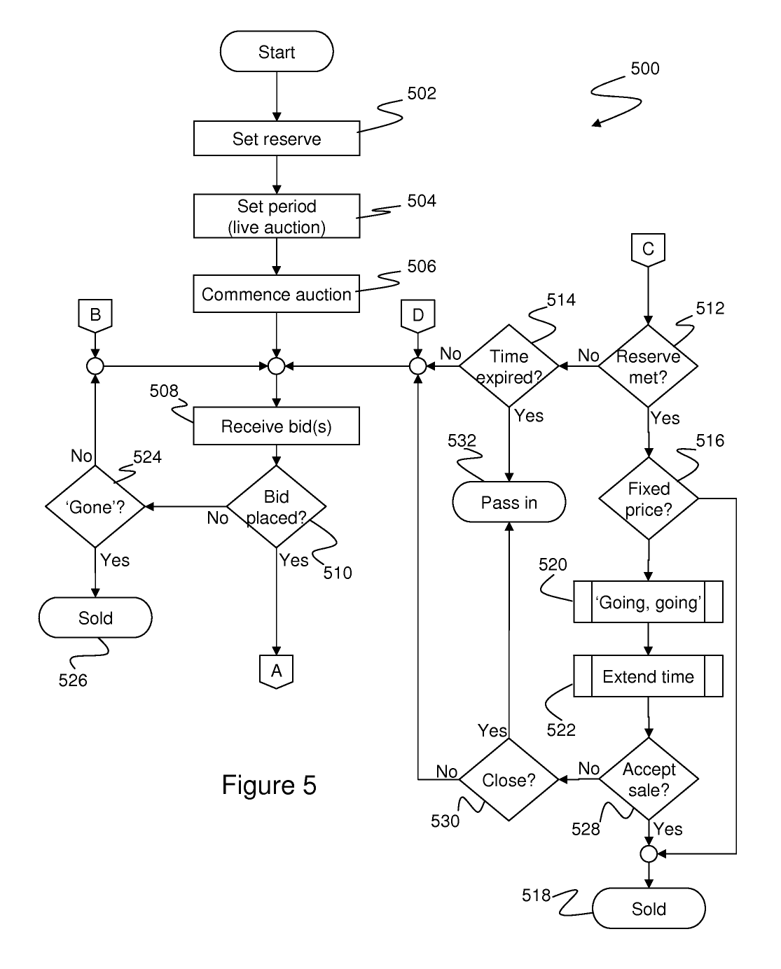

In use, the volatile storage 206 includes a corresponding body 210 of program instructions configured to perform processing and operations embodying features of the present invention, comprising various steps in the processes and functions described below with reference to FIGS. 3 to 8.

In the presently described embodiment, the program instructions 210 include instructions embodying a web-server application. Data stored in the non-volatile 204 and volatile 206 storage comprises web-based code for presentation and/or execution on client devices 106, 108 such as HTML and/or JavaScript code, facilitating a web-based implementation of an online group auction system.

The program instructions 210 may further implement an application programming interface (API), which enables software executing on a remote system to access the computer implemented apparatus via the data network to request provision of group auction services programmatically. Accordingly, services provided by the apparatus may be integrated into the remote system.

An online group auction method and system embodying the invention provides a service facilitating the sale of undivided lots, such as high-value assets, via a competitive auction to a plurality of participating bidders. The types of high-value assets that may advantageously be sold, e.g. to investors, via a group auction process include goods such as aircraft, automobiles, boats, works of art, and real estate. However, uses of embodiments in the invention are not limited to tangible assets, and it is possible to conduct online group auctions to facilitate investment in businesses, e.g. capital raising or crowd funding, in projects such as film production, in philanthropic enterprises, such as environmental, conservation and community projects, and in other intangibles such as patents, patent portfolios or other intellectual property. Further examples of essentially indivisible items which may be sold to a group of purchasers and/or investors include racehorses and sporting teams or players. The foregoing examples are provided by way of context only, and are not intended to be limiting of the potential applications of embodiments of the invention.

The characterising feature of articles, goods, properties or services sold via online group auction according to embodiments of the invention are firstly that the item for sale comprises an undivided lot, i.e. a single unit which either cannot be or has not been subdivided for separate sale, and that it is practicable for multiple individuals, who may or not be previously acquainted with one another, to jointly own the undivided unit. In particular, according to embodiments of the invention, a plurality of homogeneous shares are created, and a group auction is conducted in which multiple participating bidders are each enabled to compete to purchase one or more of the homogeneous shares.

In accordance with embodiments of the invention, the homogeneous shares are indistinguishable, are not associated with any specific components, elements or features of the undivided lot, and are freely interchangeable and exchangeable with items of a like nature of kind, including currency or an equivalent, and not only with other identical shares. The shares having these characteristics are termed ‘fungible’. Fungible shares may be on-sold, may be exchanged for other fungible shares of agreed equal value, and may be put up for re-sale in a further group auction process via embodiments of the invention.

In general terms, a group auction in accordance with embodiments of the invention may be conducted as follows. Initially, one or more vendors of high-value assets, or other suitable goods or services, submit those assets for sale via the online auction service. Submission may be conducted, for example, by registering online via the server 104, and then uploading the relevant details of the lot which is to be offered for sale by group auction. For example, in the case of a real estate property, the information that may be uploaded would include one or more photographs of the property, descriptions of the property, and other details such as the location of the property.

Subsequently, interested participants may access the server 104 to review the available listings of lots which are available for group auction. Uses who wish to participate as bidders in a group auction may be required to register via the server 104 and provide relevant personal details such as names, contact details, and payment details, to enable transactions to be completed upon the successful bidding for one or more shares in one or more of the available lots.

The server 104 subsequently co-ordinates the conduct of a group auction, as will be described in greater detail below with reference to FIGS. 3 to 8.

At the completion of the auction, payment is received from the successful bidders, shares are transferred to those bidders, and funds generated from the sale are transferred to the successful vendor. In some embodiments, the operator of the group auction service may receive a commission, e.g. a fixed payment and/or a percentage of the final sale price. Alternatively or additionally, operation of an online group auction service may be funded via other means, such as the provision of advertising on web pages provided by the server 104, or by a straight payment for listing of lots for sale by vendors. However, details of such aspects of the overall business model for operation of a group auction service embodying the invention are beyond the scope of the present disclosure, which is concerned with the technical and functional features of the online auction methods and systems.

Embodiments of the invention comprise a database which contains records relating to registered vendors, participants (i.e. registered bidders), undivided lots available for sale, details of ongoing auctions, details of shares associated with the auctions, and records of bids made by participating bidders. Conveniently, the database may be stored in the non-volatile storage 204 of the server 104, and/or may be stored or replicated in one or more remote databases accessible to the processor 202, for example via the network interface 208 or other peripheral interfaces.

A schematic diagram of exemplary database content 300 is shown in FIG. 3. It should be appreciated that the exemplary database structure 300 is schematic in nature, and need not represent the true internal organisation of any particular implementation, which may be based upon a variety of widely available database technologies. The purpose of the schematic diagram of database content 300 is to illustrate the key information held within the database, and some of the important relationships between the various records containing that information.

As illustrated, the database 300 includes records of registered vendors 302. The vendor records 302 include personal details and contact information of vendors. The database 300 further includes records of lots 304 which are available for sale by the vendors 302. The records of lots 304 may include, or reference, a variety of relevant details, such as identifying information to each lot, descriptions, photographs, and any other details as may be pertinent to the nature of the particular goods or services being offered for sale.

Also as illustrated, the database 300 includes registered bidder records 306. The bidder records 306 include personal details and contact information of bidders, and may also include details of bidder payment accounts from which funds may be drawn upon the successful acquisition of shares via an online group auction.

When one of the lots 304 is made available for sale by group auction, a corresponding auction record 308 is created. The auction records 308 contain details of upcoming, ongoing and/or past auctions. Details associated with an auction may include the identity of the lot 304 to which the auction relates, a starting time for the auction, a finishing condition for the auction, such as a target price and/or a finishing time, a reserve price and the identities of registered bidders 306 who are participating in the auction.

During the course of an auction, registered bidders 306 submit bids, which may be stored within the database in bid records 312. Bid records 312 may be maintained for all the bids, whether successful or unsuccessful, as a permanent history of the conduct of an auction. Alternatively, unsuccessful and superseded bids may be removed from the bid records 312. These, and other, alternatives for maintaining bid records 312 are details which may vary between embodiments of the invention.

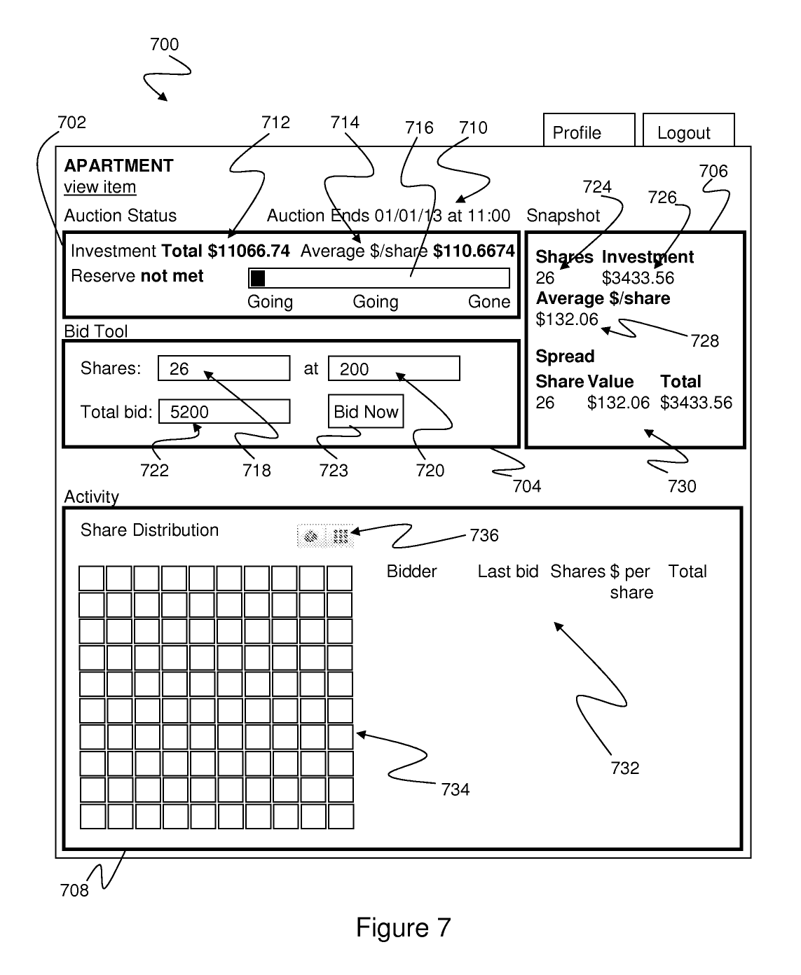

Additionally, the database 300 contains records of shares 310 associated with each of the lots 304. As an auction is conducted on a lot associated with the share records 310, successful bids 312 become associated with one or more individual shares acquired through the auction. As described in greater detail below, with reference to FIGS. 5 to 8 in particular, these relationships are dynamic and may be updated multiple times as an auction proceeds.

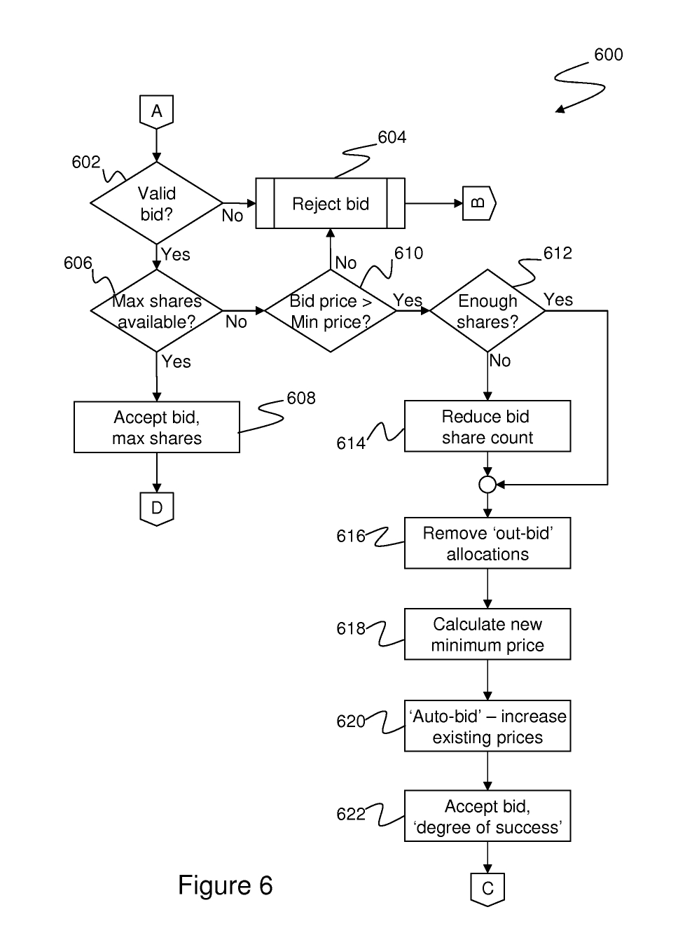

In accordance with one exemplary embodiment of the invention, a bid record 400 may contain the fields shown in FIG. 4. In particular, each bid record comprises a bidder identifier 402 corresponding with one of the registered bidders 306. Each bid record further comprises a maximum number of shares 404, and a maximum price per share 406. These two parameters of a bid are provided by the bidder within bid information which is submitted to the server 104 via the network 102 in the course of an ongoing auction. These parameters represent respectively, the maximum number of shares which the bidder wishes to acquire and the maximum price per share which the bidder is prepared to pay for those shares. As such the bidder's maximum total commitment is the product of the maximum number of shares 404 and the maximum price per share 406. As will be described in greater detail below, as a result of the auction process each such bid may be either wholly or partially successful, or may ultimately be unsuccessful, such that the bidder may eventually acquire fewer than the maximum number of shares 404 requested, at a price per share which may be less than the maximum price per share 406.

Additionally, each bid record 400 comprises a time-stamp 408. As described further below, in the exemplary embodiment the time-stamp acts as a priority field for the bid record, such that when two conflicting bids are otherwise identical, priority may be given to the earlier received bid. The time-stamp 408 is applied by the server 104 upon receipt of bid information from a bidder via the network 102.

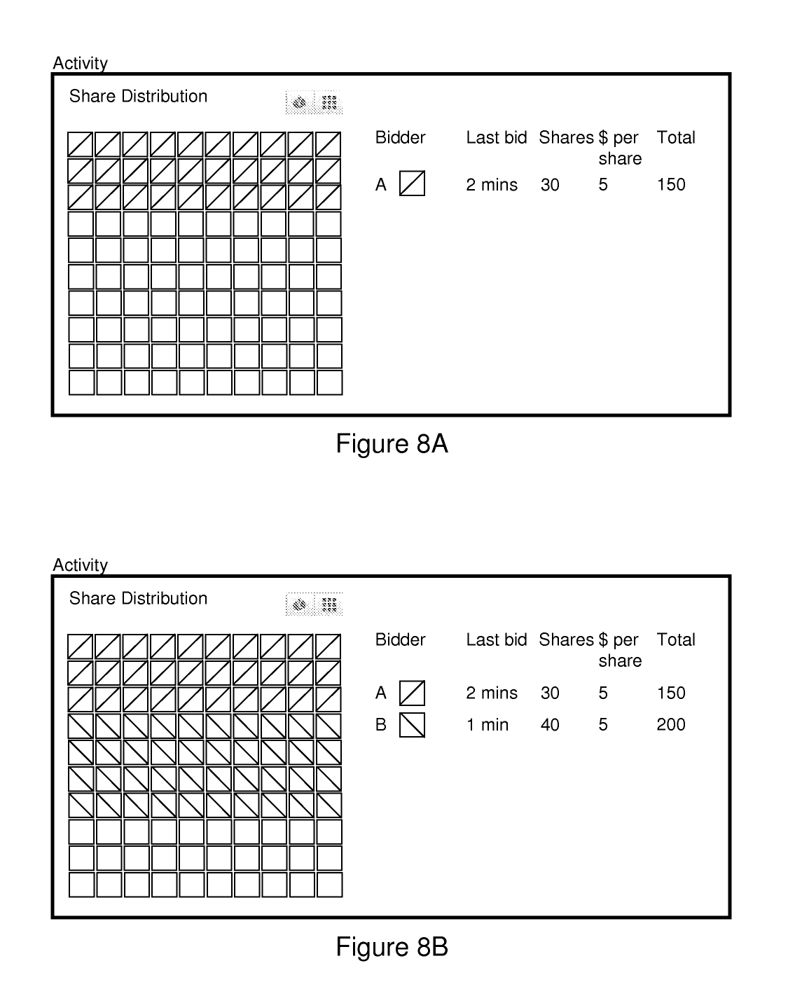

Further details of a method of conducting a group auction according to the embodiment of the invention will now be provided, with reference to the flow charts shown in FIGS. 5 and 6.

FIG. 5 shows a flow chart 500 illustrating a method for conducting a group auction embodying the invention. At step 502 a reserve price for the lot is set. As is well-known, a reserve price is the minimum price that the vendor is willing to accept for the lot to be sold. If the vendor does not have a reserve price, this step may be skipped or the reserve set to zero. At step 504, an auction period is set if the auction is to be ‘live’. A live auction is one in which the termination condition is the expiry of a predetermined time period, rather than the achievement of the reserve price. Nonetheless, a lot will only be sold in a live auction if any reserve price has been attained or exceeded.

Once the parameters of the auction have been set, the auction begins at step 506.

At step 508, the system awaits new bids. In the exemplary online embodiment, bids are submitted by participant bidders using client devices, e.g. 106, 108, and received by the server 104 via the network interface 208. At step 510 the system determines whether or not a bid has been placed. If so, then the bid is processed according to the method described in greater detail below with reference to FIG. 6.

There are three possible outcomes from the bid processing. If the bid is an invalid format, i.e. does not contain or require information, or is inconsistent with the current state of the auction (e.g. is lower than all existing accepted bids), the bid is rejected (B), and the system returns to accepting bids 508. If the bid can be covered entirely by existing unsold shares, e.g. during the early stages of the auction, then the bid is wholly successful at the minimum share price (D), and again the system returns to accepting bids 508.

The third possibility is that the bid is partially successful with fewer than the bidder's maximum number of shares being allocated at a price per share which depends upon the current state of the auction. In this case, the processing returns via (C) to step 512, at which the system determines whether or not the reserve price has been met. If not, then control passes to step 514 in which the system determines whether the current auction is a live auction, and if so, whether the predetermined time period for conducting the auction has expired. If not, then the system returns to accepting bids 508.

If, at step 512, it is determined that the reserve price has been attained or exceeded, control passes to step 516 at which the system determines whether the current auction is a fixed-price auction. If so, attaining the reserve price corresponds with the termination condition, and the auction ends with the lot being sold at step 518.

If the auction is a live auction, and the reserve price has been met, the potential now exists for the lot to be sold, once the time period expires. At step 520, the system updates the status of the auction placing it in a ‘going, going’ state, if it is not already in this state. At step 522, a time period for the auction to remain in the ‘going, going’ state is either set or extended.

Once the auction is in the ‘going, going’ state, the vendor of the lot has the option to accept the current price, and terminate the auction early. The system checks for this at 528, and if the vendor accepts the sale, the auction ends with the lot being sold at step 518.

Alternatively, the vendor has the option of closing the auction at step 530, in which case the auction will terminate without the lot being sold (i.e. being ‘passed in’) at step 532.

Turning back to the processes of awaiting bids 508 and receiving bids 510, if there is no bid placed within a minimum time period, control passes to step 524, in which the status of the auction is checked. In particular, if the system is in the ‘going, going’ state, and has been so for a set time period without the receipt of further accepted bids (i.e. causing the system to execute steps 520 and 522) then the time for further bids expires, and control passes to step 526, at which the auction ends and the lot is sold.

Finally, in the event that the reserve price is not met at step 512 and the auction time period set at 504 has expired, at step 514, then the auction will terminate with the lot not being sold, at step 532.

The auction process exemplified by the flow chart 500 in FIG. 5 may therefore be summarised as follows. For a ‘fixed price’ auction, bids are accepted until the predetermined reserve price is attained or exceeded. For a live auction, bids are accepted and processed for as long as the auction is ongoing. The reserve price must be attained or exceeded within a preset time period, otherwise the auction terminates with the lot not being sold. However, once the reserve price has been achieved, the auction continues for as long as new bids continue to be placed and accepted. Once bidding ceases, with no further new bids being accepted within a ‘going, going’ time period, then the auction terminates with the lot being sold (i.e. ‘gone’).

At any time, the vendor may be offered the option to accept the current offered price for the lot, or to close the auction without sale (i.e. lot ‘passed in’).

FIG. 6 is a flow chart 600 exemplifying, in greater detail, a method of processing a received bid following step 510. Once the bid is made, the method 600 firstly checks that the format of the bid is valid, at step 602. If not, the bid is rejected 604, and the system returns (B) to awaiting bids.

If the bid format is valid, then at step 606 the system checks to determine whether the number of shares remaining to be allocated is greater than the maximum number of shares requested in the bid. If sufficient unallocated shares are unavailable, then at step 608 the bid is accepted at the minimum share price with the full maximum number of shares allocated, and the system returns (D) to awaiting further bids.

If insufficient unallocated shares remain, then at step 610 the system determines whether the bid is high enough to acquire any of the existing allocated shares. In particular, the bidder must be willing to offer a maximum price per share which at least exceeds (i.e. ‘out-bids’) the minimum price of the existing allocated shares. If this is not the case, then the bid is not high enough and is rejected at step 604.

The system then checks, at step 612, whether there are sufficient out-bid shares available to cover the maximum number of shares requested in the bid. If not, then the bidder is unable to acquire the maximum number of shares requested in the bid, and a reduced ‘degree of success’ of the bid is determined by reducing the count of allocated shares accordingly at step 614.

At step 616, the system identifies and removes a corresponding number of existing allocated bids which are out-bid by the new bid. According to an exemplary method, the prior bids which are removed are those having the lowest maximum price per share. If there are multiple prior bids having the same maximum price per share, priority is accorded to those which were made earlier in the auction, i.e. those having the earliest time-stamp.

At step 618, a new minimum price per share is determined, based on the remaining prior bids.

At step 620, all of the existing allocated shares having a current individual share price which is less than the new minimum price per share have their share price increased to the new minimum.

At step 622, the new bid is accepted at an appropriate price per share, not less than the new minimum price per share value. In some embodiments, the price at which a new bid is accepted is equal to the new minimum price per share plus the predetermined minimum increment value, such that if the auction were to terminate at this point, the final bidder would be required to pay a higher price than that paid by otherwise comparable earlier bidders.

Having accepted the new bid, wholly or in part, control returns (C) to step 512 of the main auction process 500.

The bid processing method 600 may therefore be briefly summarised as follows. In order to acquire a share allocation, a new bid must either acquire previously unallocated shares, or must out-bid a prior bid for one or more allocated shares. In order to out-bid a prior bid, the new bidder must be willing to pay a maximum price per share which is higher than the maximum price per share offered by a previous bid. In this case, the prior bid (or bids) which have been out-bid are ‘pushed out’ of the auction, and the minimum price of all shares raised to match a corresponding new minimum value. The new bid is accepted, wholly or partly, at a minimum, or slightly higher, current price.

Notably, a new bid which is higher than the current minimum price per share, but not high enough to beat the maximum price per share offered by any other prior bidders, will still result in the minimum price share being elevated to match or slightly exceed the maximum price offered by the new bid, even though the new bid will be unsuccessful. That is, even though the new bidder was not prepared to pay as high a price as the maximum offered by any previous bidder (and therefore could not succeed), the prior bidders are nonetheless no longer able to acquire shares for less than the maximum price offered by the new bidder.

In general, the minimum current price of allocated shares can never be less than the maximum price per share bid by the last unsuccessful bidder.

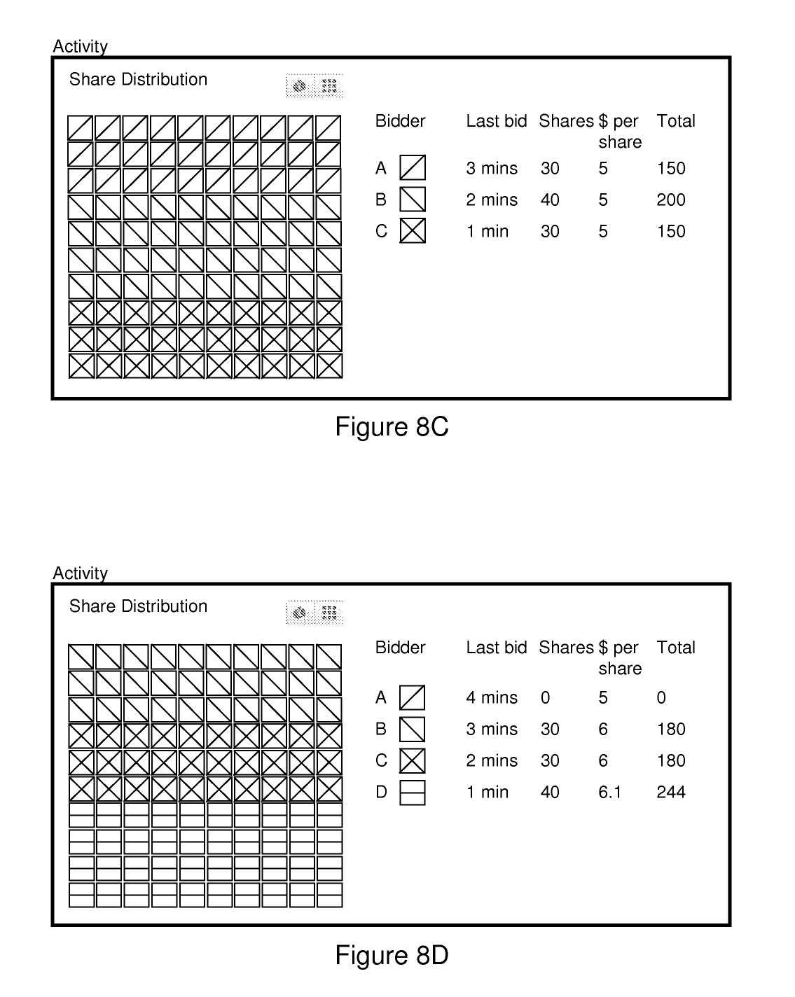

Turning now to FIG. 7, there is shown an exemplary user interface display 700 presented to a participant bidder in the course of an auction. It is assumed that the bidder is registered with the site, and also registered to participate in the auction, in a conventional manner, e.g. by signing up and providing verified personal and transaction account details.

The display 700 comprises four distinct regions. These regions are: an auction status pane 702, a bid tool pane 704, a snapshot pane 706, and a visualisation pane 708.

The status pane 702 summarises the current state of the auction. For a ‘live’ auction, the time at which the auction ends 710 is shown above the status pane 702. The current total value of all shares is shown 712, along with the average dollar value per share 714. The status pane also indicates whether or not the reserve has been met, and includes a graphical indication 716 to show when a live auction enters the ‘going, going’ state, thereby informing the bidder that the lot may now be potentially sold if further bids are not forthcoming.

The bid tool pane 704 is the area within which the bidder is able to submit a new bid. Within the pane 704 are text entry fields enabling entry of the maximum number of shares 718, and the maximum price per share 720. These values are used to populate a bid record 400 along with the bidder identifier and the time at which the bid is received. The bid tool pane 704 also shows the total commitment 722 corresponding with the bid, which is the amount that the bidder will have to pay if allocated the full maximum number of shares 718 at the maximum price 720. Submission of the bid is completed by clicking on the ‘bid now’ button 723.

The snapshot pane 706 summarises the current position of the bidder. The pane 706 shows the total number of allocated shares 724, and the corresponding total investment 726 of the bidder, at the current point in time. Also shown is the average price per share, 728 that the bidder is paying for the allocated shares 724.

A participant may have made multiple bids in the course of the auction, any or all of which may have resulted in allocation of shares, at differing prices depending upon the status of the auction at the time. Accordingly, a summary of such distinct allocations resulting from separate bids is provided in the snapshot pane, as ‘spread’ values 730.

The visualisation pane 708 allows the bidder to obtain an overview of the current status of the auction, including allocations to all bidders 732, and a visual representation 734 of the allocated shares. In the visualisation 734 shown in FIG. 7, a grid is used, in which each box represents a share. The decoration (colour, ornamentation, or the like) of each box corresponds with the particular bid, or bidder, and the boxes are ordered such that shares corresponding with the lowest current share price appear in the top left hand corner, moving through to shares at the highest current share price in the bottom right hand corner.

While the grid pattern 734 represents one possible visualisation of an ongoing auction, it will appreciated that many other visualisations may be devised. For example, the current status of the auction may be represented as a pie chart, which in the exemplary embodiment is an option available by clicking on the corresponding visualisation button 736. Visualisation may alternatively be provided, for example, in the form of a bar chart or any other suitable representations, charts, graphs, infographics and so forth, in static or dynamic form.

For auctions in which there are a large number of shares, each element in the visualisation may correspond with multiple shares, rather than a single share. Alternatively, or additionally, large numbers of shares may be represented in a three-dimensional format, such as a cube, rather than a two-dimensional grid 734 The user may be able to interact with the visualisation, for example by zooming, panning and/or rotating an image in order to view different parts of the visualisation graphics. Or such alternative and/or equivalent forms of visualisation as may be readily implemented by those having skill in the relevant art of computer programming fall within the scope of the embodiments of the present invention.

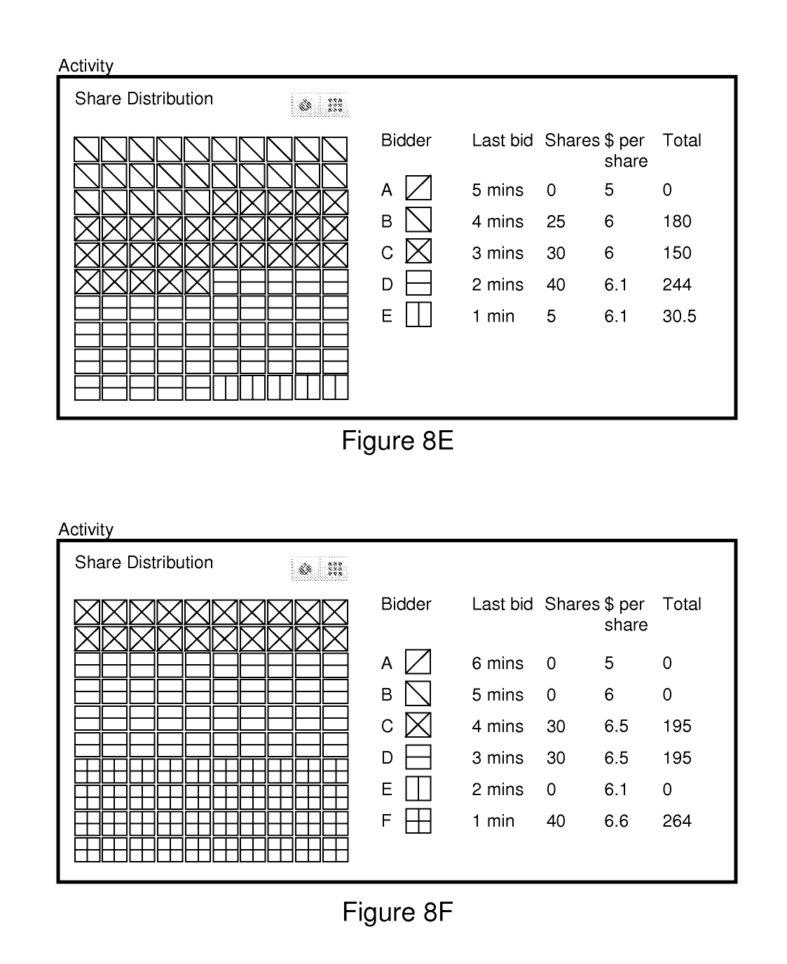

By way of example, FIGS. 8A to 8F illustrate the evolution of the visualisation pane 708 over the course of six initial bids of a live auction. In accordance with the example shown, 100 shares are available in an auction for a lot having a reserve price of $600. A minimum bid of $5.00 per share is set, and minimum increments of 10 cents per share.

In a first bid, a bidder (A) requests a maximum of 30 shares at a maximum price per share of $5.00. Since no shares are allocated as yet, this bid is wholly successful, resulting in the visualisation shown in FIG. 8A.

A second bidder (B) offers a maximum of $6.00 per share for up to 40 shares. Again, this bid is wholly successful, being allocated 40 shares at the current minimum price of $5.00 per share as shown in the visualisation of FIG. 8B.

A third bidder (C) offers $7.00 per share maximum, for a maximum of 30 shares. Again, the bid is wholly accepted, allocating 30 shares at the current minimum price of $5.00 per share. This is shown in the visualisation of FIG. 8C. At this point, the total price of the lot is $500, which remains below the reserve price.

A new bidder (D) enters a bid, offering an a maximum of $6.50 per share, for a maximum of 40 shares. Bidder D is therefore willing to pay more than either bidder A or bidder B. The request for 40 shares completely displaces the 30 shares of A and 10 of the shares of B. The minimum share price rises to $6.00 (i.e. B's maximum bid), while the new bidder D pays $6.10 per share, i.e. the current minimum plus the minimum increment.

The resulting status of the auction is illustrated in visualisation of FIG. 8D. The total value of the lot is now $604, i.e. the reserve price has been reached, and the auction would enter the ‘going, going’ state.

A new bidder (E) enters the auction, with a bid for a maximum of 5 shares at a maximum price of $6.20. This bid displaces five of B's remaining allocated shares, since B is willing to pay only $6.00. The minimum share price remains at $6.00, because this is B's maximum bid. Bidder C retains the full allocation of 30 shares at $6.00 per share, bidder D retains the full allocation of 40 shares at $6.10 per share, and bidder E enters with five shares at $6.10 per share. The total value of the lot is now $604.50.

The resulting status of the auction is shown in the visualisation of FIG. 8E.

Bidder F now enters the auction, offering a maximum of $7.00 for each of up to 45 shares. New bidder F is thus willing to pay more than bidders B, D and E, and is willing to pay up to the same price as bidder C. The new bid therefore displaces D's 25 shares, E's 5 shares, and 10 of D's 40 shares, for which D was willing to pay up to $6.50. As a result, $6.50 becomes the new minimum price. Bidder C retains the full requested allocation of 30 shares now at $6.50. Bidder D retains 30 of the previous 40 allocated shares also at $6.50. New bidder F receives the full requested allocation of 40 shares, at a price per share of $6.50. This situation is shown in the visualisation of FIG. 8F.

By way of further clarification of the exemplary method of processing new bids, Table 1 contains a pseudocode definition of the bid processing method.

While the foregoing description discloses exemplary embodiments of the invention, it will be understood that a number of variations are possible, within the overall scope of the invention as defined in the claims appended hereto.

For example, in one further variation participating bidders may be permitted to acquire ‘preferential shares’ by paying a price premium to remove those shares from the competitive auction, in a manner similar to the ‘buy now’ option available in many conventional online auction services. Shares acquired at the preferential price, which may be fixed in advance by the vendor, or determined as a percentage premium on top of a current maximum share price, are locked in for the bidder, and can no longer be allocated to a subsequent competitive bid. In some embodiments, in the event that the minimum price per share becomes equal to, or greater than, the preference share price, then the auction would terminate. In other embodiments, remaining competitive bidders may be permitted to continue bidding, even though they are now paying a higher price than the previous preferential share price. In this situation, an early acquirer of preferential shares obtains a price benefit compared to the final competitive minimum share price.

In another variation, preferences may be attributed to share for which a bidder was prepared to pay more, i.e. shares for which a higher maximum price was offered, even though bidding may close with the shares allocated at below that price. Additional benefits appropriate to the lot may be provided to those bidders offering higher maximum bids, such as gifts, free shipping, preferential seating allocations, and so forth.

In another variation, the system may permit previously sold shares to be returned for auction via the same system. In this way, an individual investor may opt to sell out of some or all of their allocation, without requiring the other investors also to sell. Shares belonging to the other investors remain locked and unavailable for allocation, while the shares available for auction are subject to competitive bids by participants, which may include any or all of the existing share owners and/or more new bidders.

In yet another variation, the number of shares may be dynamic, rather than fixed. In some embodiments, shares may be ‘split’ in response to high demand, with the existing bidders' allocations, maximum price per share, and current price per share all being adjusted accordingly, so that the total investment and total commitment of each bidder remains constant before and after the share split.

In other embodiments, the number of shares may be reduced, e.g. in response to high demand. In one particular scenario, an embodiment of the invention may be employed for the purposes of raising a fixed maximum sum, for example in a capital-raising or other form of funding round. In such a scenario, the undivided lot may represent a percentage stake in an investment vehicle or entity, such as a company. Once all shares have been allocated, and the maximum funding raised, further demand signals that the market considers the offered stake to be worth more than the maximum sum. In this case, shares may be effectively ‘withdrawn’ from the offering, and retained by the company, reducing the number of homogeneous shares comprising the undivided lot. One or more of the remaining shares may then be allocated to a new bidder offering a higher maximum price per share than one or more existing bids, and the prices of one or more of the remaining shares increased, up to the corresponding maximum price in each case, such that the total maximum value of the lot is maintained.

In still a further variation, an embodiment of the method and system may be employed to conduct a ‘reverse’ auction, i.e. one in which a buyer seeks to acquire shares in an undivided lot, and existing shareholders are able to compete to offer their existing share allocations, in whole or in part, at competitive prices. In this case, the winning vendor is the one ultimately offering the lowest price to the buyer. Such an auction may be conducted using an embodiment of the invention in which bid and allocation price parameters are reversed, i.e. the share price starts at a predetermined maximum price-per-share, and participating vendors place bids comprising a minimum price at which they are willing to sell. Reduction of share prices may be performed using the same algorithms used to increase share prices in the conventional auction process described in detail above, with those bidders offering higher minimum prices being displaced by more competitive bids. The auction may conclude after a predetermined time, or when the total price of the lot reaches a predetermined ‘resever’ set by the buyer, or on some other termination condition.

Further variations as would be apparent to persons skilled in the art are also within the scope of the invention, as defined by the appended claims.

TABLE 1
Bid processing algorithm pseudocode

Bidder places new bid
If new bid is valid Then

currentSharePrice => 0.0
newShareCount => new bid share count
availableShareCount => number of shares available for listing that

have a share price lower than new bid's share price

If availableShareCount < newShareCount Then

newShareCount => availableShareCount

End If
activeBids[ ] => list of all bids that have a share price lower than the

new bid's share price

Loop Through activeBids

activeBid => iteration of activeBids
activeBidShareCount => activeBid share count
If newShareCount > activeBidShareCount Then

newShareCount => newShareCount − activeBidShareCount
currentSharePrice => activeBid maximum share price
Remove activeBid

Else

activeBidShareCount => activeBidShareCount −
newShareCount
Save activeBid with new activeBidShareCount
currentSharePrice => activeBid current share price
newShareCount => 0

End If

End Loop
If any existing activeBids were altered Then

currentSharePrice => currentSharePrice + (appropriate increment
price)

End If
new bid's current share price => currentSharePrice
Save new bid
Check if listing reserve price is met

Else

increase any existing bids' share prices appropriate to current bid
share price

(i.e. autobid)

return and notify Bidder of failed bid

End If

We claim:

1. A method for conducting a group auction of homogeneous shares in an undivided lot via a data network, the method comprising steps of:
providing a server computer having an associated database containing details of an undivided lot available for auction, and information representing a share offering, comprising a number of homogeneous shares in the undivided lot, each share having an associated individual share price;
the server receiving from one of a plurality of bidders, via the data network, new bid information comprising data identifying a maximum number of shares, and data identifying a maximum price per share;
the server determining a degree of success of the bid based on an extent to which the maximum price per share exceeds a current individual share price of one or more of the homogeneous shares; and
the server updating the information representing the share offering in accordance with the determined degree of success of the bid.

2. The method of claim 1 comprising repeating steps of:
receiving one or more further bids from the plurality of bidders;
determining a degree of success in each further bid; and
updating the information representing the share offering, until an auction termination condition is satisfied.

3. The method of claim 2 wherein the termination condition is the expiry of a predetermined time limit.

4. The method of claim 2 wherein the termination condition is the attainment of a desired total valuation of the undivided lot.

5. The method of claim 1 wherein the step of determining the degree of success of the bid comprises:
determining whether the number of shares available is greater than the maximum number of shares identified in the new bid information; and
if so, then determining the degree of success to be equal to the maximum number of shares,
wherein the information representing the share offering is updated to reflect an allocation to the bidder of the same maximum number of the homogeneous shares at a minimum share price.

6. The method of claim 1 wherein the step of determining the degree of success of the bid comprises:
determining whether the number of shares available is less than the maximum number of shares identified in the new bid information; and
if so, then determining the degree of success in the new bid to be equal to a number of homogeneous shares, up to the identified maximum number, having an associated maximum price per share based upon a prior bid which is lower than the maximum price per share identified in the new bid information,
wherein the information representing the share offering is updated to reflect an allocation to the bidder of the number of shares corresponding with the determined degree of success.

7. The method of claim 1 wherein each allocated homogeneous share comprises an associated bidder and an associated maximum price, and the step of determining the degree of success of the bid comprises:
identifying all shares having an associated maximum price which is less than the maximum price per share of the new bid, wherein the degree of success is equal to the lesser of:
the number of shares so identified, and
the maximum number of shares identified in the new bid information.

8. The method of claim 7, wherein each allocated homogeneous share further comprises an associated priority relative to more other allocated shares, and the information representing the share offering is updated using a method comprising:
identifying a number of out-bid shares equal to the degree of success, the out-bid shares being those shares having the lowest maximum price per share and then the lowest priority relative to other allocated shares; and
associating the out-bid shares with the bidder, the maximum price of the new bid, and a new minimum priority relative to all prior allocated shares.

9. The method of claim 8 wherein the step of updating the information representing the share offering further comprises updating the associated individual share price of one or more of the homogeneous shares.

10. The method of claim 9 wherein updating the associated individual share price comprises setting the individual share price of shares newly associated with the bidder, and of all prior allocated shares having an individual share price less than the maximum price per share of out bid shares, to the maximum share price per share of out-bid shares.

11. The method of claim 6 wherein the step of updating the information representing the share offering comprises reducing the number of homogeneous shares comprising the undivided lot, while increasing the individual share price of one or more of the remaining shares to maintain the total value of the undivided lot.

12. The method of claim 1, further comprising:
providing to the bidder a visualisation of the information representing the share offering, wherein the visualisation comprises a two- or three-dimensional graphical representation of one or more of:
the number or proportion of shares currently allocated;
the absolute or relative price per share of all shares currently allocated;
the shares currently allocated to the bidder;
the shares currently allocated to one or more other bidders;
the total current value of the undivided lot, calculated as the sum of all individual prices; and
the total current commitment of the bidder, calculated as the sum of individual share prices of all shares allocated to the bidder.

13. The method of claim 12 wherein the visualisation comprises a time element including one or more current or past values of visualised quantities.

14. The method of claim 1 wherein one or more of the homogeneous shares are marked as unavailable for allocation, whereby the step of determining a degree of success of the bid excludes the unavailable shares.

15. The method of claim 1 wherein the bid information comprises a preferential bid, and the step of updating the information representing the share offering comprises:
allocating the requested number of shares at a premium price; and
marking the allocated shares as unavailable for further allocation.

16. The method of claim 1 further comprising a step of dynamically adjusting the number of homogeneous shares responsive to a condition.

17. The method of claim 16 wherein the step of dynamically adjusting comprises splitting one or more of the homogeneous shares such that each successful bidder obtains an allocation of a larger number of shares, at a lower price per share, wherein the total commitment of each successful bidder remains fixed.

18. A computer implemented apparatus for conducting a group auction of homogeneous shares in an undivided lot via a data network, wherein the apparatus comprises:
at least one processor;
a network interface, operatively associated with the processor and providing access to the data network;
at least one memory device, operatively associated with the processor; and
a database, accessible to the processor, which contains details of an undivided lot available for auction, and information representing a share offering comprising a number of homogeneous shares in the undivided lot, each share having an associated individual share price,
wherein the memory device contains program instructions which, when executed by the processor, cause the apparatus to implement a method comprising steps of:
receiving from one of a plurality of bidders via the data network, new bid information comprising data identifying a maximum number of shares, and data identifying a maximum price per share;
determining a degree of success of the bid based on an extent to which the maximum price per share exceeds a current individual share price of one or more of the homogeneous shares; and
updating the information representing the share offering in accordance with the determined degree of success of the bid.

19. The apparatus of claim 18 wherein the memory device contains further programming instructions comprising an application programming interface (API), which enables software executing on a remote system to access the computer implemented apparatus via the data network to request execution of auction operations, whereby services provided by the apparatus may be integrated into the remote system.

20. A method for conducting a reverse group auction of homogeneous shares in an undivided lot via a data network, the method comprising steps of:
providing a server computer having an associated database containing details of an undivided lot having shares allocated to one or more shareholders, and information representing a purchase offer of a buyer, comprising a requested number of homogeneous shares in the undivided lot, each share having an associated individual share price;
the server receiving from one of the shareholders, via the data network, new bid information comprising data identifying a maximum number of shares, and data identifying a minimum price per share;
the server determining a degree of success of the bid based on an extent to which the minimum price per share is lower than a current individual share price of one or more of the requested number of homogeneous shares; and
the server updating the information representing the share offering in accordance with the determined degree of success of the bid.

21. The method of claim 20 comprising repeating steps of:
receiving one or more further bids from the plurality of shareholders;
determining a degree of success in each further bid; and
updating the information representing the share offering, until an auction termination condition is satisfied.

22. The method of claim 21 wherein the termination condition is the expiry of a predetermined time limit.

23. The method of claim 21 wherein the termination condition is the attainment of a desired total valuation of the requested number of homogeneous shares.

24. A computer implemented apparatus for conducting a reverse group auction of homogeneous shares in an undivided lot via a data network, wherein the apparatus comprises:
at least one processor;
a network interface, operatively associated with the processor and providing access to the data network;
at least one memory device, operatively associated with the processor; and
a database, accessible to the processor, which contains details of an undivided lot having shares allocated to one or more shareholders, and information representing a purchase offer of a buyer, comprising a requested number of homogeneous shares in the undivided lot, each share having an associated individual share price,
wherein the memory device contains program instructions which, when executed by the processor, cause the apparatus to implement a method comprising steps of:
receiving from one of the shareholders via the data network, new bid information comprising data identifying a maximum number of shares, and data identifying a minimum price per share;
determining a degree of success of the bid based on an extent to which the minimum price per share is lower than a current individual share price of one or more of the requested number of homogeneous shares; and
updating the information representing the share offering in accordance with the determined degree of success of the bid.

25. The apparatus of claim 24 wherein the memory device contains further programming instructions comprising an application programming interface (API), which enables software executing on a remote system to access the computer implemented apparatus via the data network to request execution of auction operations, whereby services provided by the apparatus may be integrated into the remote system.
